(19) United States
(12) Patent Application Publication
(10) Pub. No.: US 2025/0259987 A1
(43) Pub. Date: Aug. 14, 2025

(54) REMOVAL OF AN IMPURITY LAYER FROM MOLTEN LITHIUM FOR IMPROVING WETTABILITY ONTO CURRENT COLLECTORS

(71) Applicant: GM GLOBAL TECHNOLOGY OPERATIONS LLC, Detroit, MI (US)

(72) Inventors: Diptak BHATTACHARYA, Royal Oak, MI (US); Shaomao Xu, Sterling Heights, MI (US); Hassan Ghassemi-Armaki, Northville, MI (US); Sayed Youssef Sayed Nagy, Troy, MI (US); Nicholas Paul William Pieczonka, Windsor (CA); Andrew Clay Bobel, Troy, MI (US); Robin James, Rochester Hills, MI (US); Jennifer Therese Bracey, Holly, MI (US)

(21) Appl. No.: 18/440,529

(22) Filed: Feb. 13, 2024

(51) Int. Cl. H01M 4/04; H01M 4/02; H01M 4/38

(52) U.S. Cl. CPC H01M 4/0483; H01M 4/0404; H01M 4/0435; H01M 4/382; H01M 2004/027

(57) ABSTRACT

A method for removing impurities from a bath including molten lithium includes melting bulk lithium in a bath to form molten lithium including an impurity layer; immersing one end of one of a metal foam and a metal mesh in the bath; moving the one of the metal foam and the metal mesh horizontally through the bath to remove the impurity layer; and removing the one of the metal foam and the metal mesh from the bath.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to methods for removing an impurity layer from molten lithium to improve wettability onto current collectors for electrodes of battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include one or more cathode electrodes, anode electrodes, and separators arranged in a battery cell enclosure. The cathode electrodes include a cathode active material layer arranged on a cathode current collector. The anode electrodes include an anode active material layer arranged on an anode current collector.

### SUMMARY

A method for removing impurities from a bath including molten lithium includes melting bulk lithium in a bath to form molten lithium including an impurity layer; immersing one end of one of a metal foam and a metal mesh in the bath; moving the one of the metal foam and the metal mesh horizontally through the bath to remove the impurity layer; and removing the one of the metal foam and the metal mesh from the bath.

In other features, the one of the metal foam and the metal mesh is made of a material selected from a group consisting of aluminum, magnesium, and alloys thereof. The one of the metal foam and the metal mesh includes the metal foam. The one of the metal foam and the metal mesh includes the metal mesh. The metal mesh includes a plurality of mesh layers that are stacked.

In other features, the one of the metal foam and the metal mesh has a thickness in a range from 3 to 5 mm.

In other features, the impurity layer has a thickness, and the one of the metal foam and the metal mesh is inserted below a surface of the bath greater than or equal to the thickness of the impurity layer.

In other features, the impurity layer has a thickness in a range from 1 mm to 3 mm below a surface of the bath.

In other features, the method includes coating an anode current collector in the bath after removing the impurity layer.

A system for coating anode current collectors with molten lithium includes a bath including molten lithium including an impurity layer. A conveyor assembly includes one of a continuous metal mesh and a continuous metal foam arranged around rollers. The one of the continuous metal foam and the continuous metal mesh is made of a material selected from a group consisting of aluminum, magnesium, and alloys thereof. The conveyor assembly is arranged with the one of the continuous metal mesh and the continuous metal foam inserted below a surface of the bath greater than or equal to a thickness of the impurity layer.

In other features, a sensor is configured to sense an impurity level of the impurity layer. A positioning device is configured to insert and remove the conveyor assembly from the bath. A controller is configured to remove the conveyor assembly from the bath in response to the impurity level being below a predetermined impurity level.

On other features, a current collector feed assembly includes a current collector roll configured to supply a current collector, a roller immersed in the bath, and a roll configured to receive an anode electrode. A sensor is configured to sense an impurity level of the impurity layer.

In other features, a positioning device is configured to insert and remove the current collector feed assembly from the bath. A controller is configured to remove the conveyor assembly from the bath in response to the impurity level being above a predetermined impurity level. The one of the continuous metal foam and the continuous metal mesh includes the continuous metal mesh. The continuous metal mesh includes a plurality of mesh layers that are stacked.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell including anode electrodes, cathode electrodes, and separators according to the present disclosure;

FIG. 2A is a plan view of an example of an anode current collector according to the present disclosure;

FIG. 2B is a side cross section of an example an anode electrode including a mesh current collector coated with lithium according to the present disclosure;

FIG. 3 is a side cross section of an example of bulk lithium (such as lithium foil or bar) with a native oxide layer prior to melting;

FIG. 4 is a side cross section of an example of a bath including molten lithium with an upper layer including impurities;

FIGS. 5A and 5B are plan and perspective views of examples of metal mesh and foam, respectively, according to the present disclosure;

FIG. 6 is a side cross section of an example of a bath including molten lithium with an upper layer including impurities being removed by the metal mesh or foam according to the present disclosure;

FIG. 7 is a flowchart of an example of a method for removing impurities from a bath of molten lithium according to the present disclosure;

FIG. 8 is a side cross section of an example of a bath including molten lithium with an upper layer including impurities being removed by a conveyor including continuous metal mesh or foam according to the present disclosure;

FIG. 9 is a side cross section of an example of a bath including an anode current collector fed into the bath of FIG. 8 according to the present disclosure; and

FIG. 10 is a side cross section of an example of a bath including molten lithium with an upper layer including impurities being removed by a conveyor including continuous metal mesh or foam and an anode current collector fed into the bath according to the present disclosure.

In the drawings, reference numbers may be reused to identify similar and/or identical elements.

### DETAILED DESCRIPTION

While the present disclosure relates to methods for removing an impurity layer from a bath including molten lithium prior to coating anode current collectors with the molten lithium in the bath, the method can be used for removing an impurity layer from a lithium bath prior to coating other types of substrates.

The present disclosure relates to a method for removing an impurity layer from a surface of a bath including molten lithium prior to wetting of the lithium onto a current collector for an electrode of a battery cell. Lithium metal is highly reactive with oxygen, moisture, and nitrogen. A native surface oxide layer forms on commercially available lithium metal foils/bars. When lithium is melted, a layer of impurities forms on the surface layer of the molten lithium. The impurities are rich in nitride and oxides/carbonates, which can develop due to poor nitrogen or oxygen control in a glove box environment.

The impurities located on the surface of the molten lithium are hard to remove from the molten bath. When the impurity layer forms, the molten lithium in the bath cannot be used to coat the anode current collectors. As such, the impurities need to be removed quickly and effectively for both manufacturing speed and anode electrode quality.

A method for removing the impurities according to the present disclosure includes using a metal mesh/foam to remove or skim impurities from a molten lithium bath. In some examples, the metal mesh/foam is made of a material (such as aluminum (Al), magnesium (Mg), and their alloys) that is more reactive with the impurities than lithium. For example, magnesium is more stable with oxides than lithium. Therefore, magnesium is a good material for removing the oxide-based impurities. Both aluminum and magnesium are more stable with nitrides than lithium. Therefore, aluminum, magnesium and their alloys are good materials for removing the nitride-based impurities.

In some examples, the metal in the metal foam/mesh reacts with both the lithium melt and impurities on a surface layer of the molten lithium. An interfacial reaction between the lithium/impurity and the metal mesh/foam causes a lithium layer along with the impurities or slag to adhere to the metal mesh/foam.

The pores of the metal mesh/foam offer additional spaces and surface area to entrap the impurities. The method provides an effective way to quickly remove impurities from the lithium bath and expose the liquid lithium for successful wetting onto current collectors when manufacturing lithium anode electrodes.

More particularly, the method according to the present disclosure uses porous metal (e.g., aluminum, magnesium, and their alloys) to clean impurities from the surface of a molten lithium bath. The metal spontaneously reacts with the surface lithium layer and undergoes a surface reaction with the components of the impurity layer, such as the lithium-rich nitride and/or oxides in the impurity layer.

In some examples, the metal that is used includes pure aluminum or an aluminum alloy having solubility for lithium and greater nitride stability as compared to lithium. Aluminum spontaneously reacts with lithium as well as the impurities (e.g., oxide or nitride) in the impurity layer. In some examples, the metal that is used includes pure magnesium or magnesium alloy having solubility for lithium and greater oxide and nitride stability as compared to lithium. Magnesium spontaneously reacts with lithium as well as the impurities (oxide or nitride) in the impurity layer.

In some examples, the metal is in the form of a metal mesh or a metal foam. The porous structure of the metal mesh/foam helps to trap and remove the impurities. In some examples, the metal mesh/foam is about 3-5 mm thick so that it can be partially immersed into the molten lithium bath. In some examples, the impurity layer is in a range from 1 to 3 mm thick. In some examples, the metal mesh/foam is dipped about 1 to 3 mm below the surface of the bath to skim the surface of the lithium layer along with the impurities on the surface. In some examples, the metal mesh/foam is dipped slightly below the surface of the bath to skim the surface of the lithium layer along with the impurities on the surface to minimize the reaction with the molten lithium.

In some examples, the metal mesh/foam is made of aluminum that is anodized. Anodizing forms an aluminum oxide (Al₂O₃) layer. The aluminum oxide layer avoids lithiating the Al while triggering an interfacial reaction between the oxide and the lithium causing the sticking of the surface lithium layer (along with the impurities) to the metal mesh/foam.

In some examples, a manufacturing line for the anode electrodes is equipped with a bath cleaning assembly. In some examples, an interchangeable lithium coating and impurity removal assemblies are used. In other examples, the manufacturing line includes both the lithium coating and the impurity removal assemblies for continuous removal of the impurity layer during production.

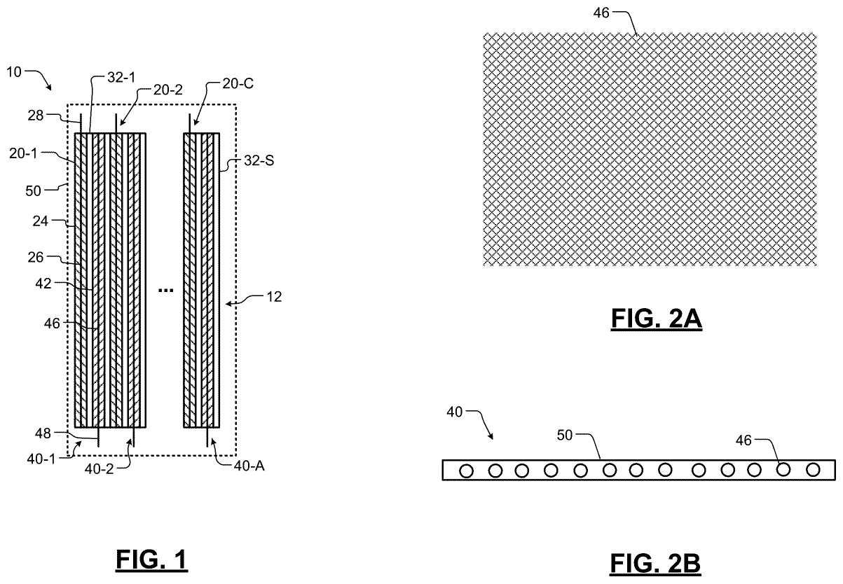

Referring now to FIG. 1, a battery cell 10 includes C cathode electrodes 20, A anode electrodes 40, and S separators 32 arranged in a predetermined sequence in a battery cell core 12, where C, S and A are integers greater than zero. The C cathode electrodes 20-1, 20-2, . . . , and 20-C include cathode active material layers 24 arranged on one or both sides of a cathode current collector 26.

The A anode electrodes 40-1, 40-2, . . . , and 40-A include anode active material layers 42 arranged on one or both sides of the anode current collectors 46. In some examples, the A anode electrodes 40 and the C cathode electrodes 20 exchange lithium ions during charging/discharging. In some examples, the anode active material layer 42 includes lithium (applied using molten lithium) onto the anode current collector 46 (e.g., a mesh such as copper).

In some examples, the cathode active material layers 24 and/or the anode active material layers 42 comprise coatings including one or more active materials, one or more conductive additives, and/or one or more binder materials that are applied to the current collectors (e.g., using a wet or dry roll-to-roll process).

In some examples, the cathode current collector 26 and/or the anode current collector 46 comprises metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell core 12. The external tabs 28 and 48 are connected to terminals of the battery cells.

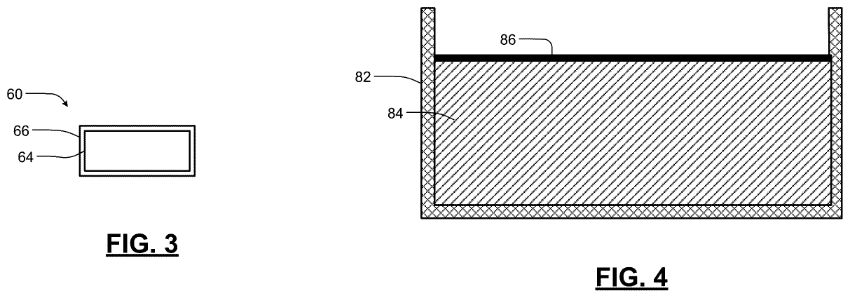

Referring now to FIGS. 2A and 2B, an example of an anode current collector 46 is shown. In FIG. 2A, the anode current collector 46 is shown. In FIG. 2B, the anode electrode 40 includes the anode current collector 46 coated with a lithium layer 50.

Referring now to FIGS. 3 and 4, a bath of molten lithium may be used to coat the anode current collector. In FIG. 3, melting of bulk lithium 60 (e.g., a foil or bar) creates molten lithium (desired) and impurities (not desired). The bulk lithium 60 is shown prior to melting and includes a lithium metal body 64 having a native oxide layer 66. In FIG. 4, a bath 82 includes molten lithium 84. An impurity layer 86 rises to the top surface and includes impurities that should be removed from the bath 82 prior to coating of anode current collectors.

Lithium metal is highly reactive with oxygen, moisture, and nitrogen. Commercially available lithium metal foils/bars have a native surface oxide. When the bulk lithium is melted in a crucible, the surface of the melted lithium is covered with a sticky layer of impurities. An impurity layer (rich in nitride and oxides/carbonates) can develop on the molten lithium due to poor N₂ or O₂ control in a glove box environment. The impurities on the surface of molten lithium are extremely sticky with the underlying lithium and hard to remove from the molten bath.

X-ray photoelectron spectroscopy (XPS) analysis of the impurity layer indicates that the impurity layer includes a mixture of lithium carbonate (LiCO₃), lithium oxide (Li₂O), and lithium nitrate (LisN) species. Impurities need to be removed from the surface of the molten lithium bath to enable uniform wetting of “pure” lithium onto anode current collectors. The impurities prevent direct contact between the anode current collector and the lithium, thereby hindering wetting onto the anode current collector. The impurities stick to the anode current collector and degrade the quality of the anode electrode. Impurities stuck to the anode electrode create a rough anode surface and non-uniform lithium deposition, which is untenable for practical production applications. The impurity layer is difficult to break, trap, and/or remove using tools. The impurities do not stick to tools made of materials such as stainless steel.

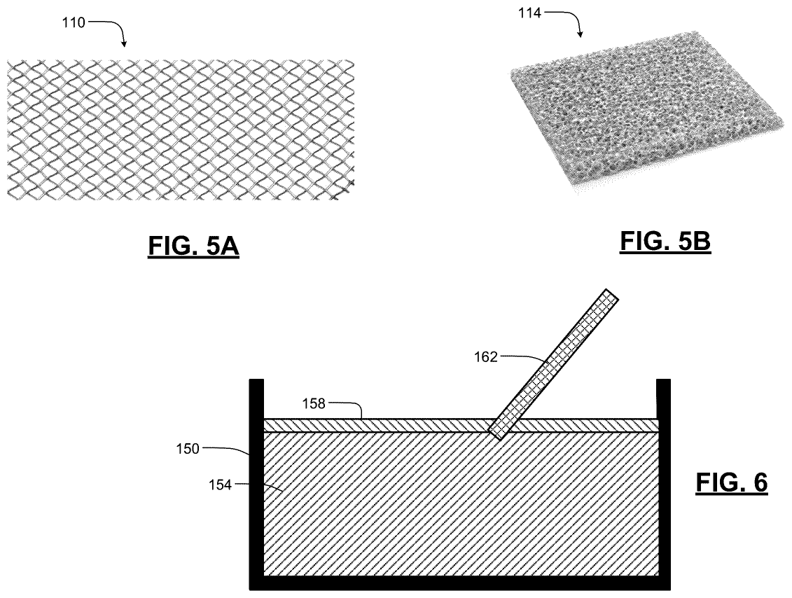

Referring now to FIGS. 5A to 6, a metal mesh 110 (FIG. 5A) or a metal foam 114 (FIG. 5B) can be used to remove the impurities from a bath 150. In FIG. 6, the bath 150 includes molten lithium 154 and a layer 158 includes impurities. A metal mesh or foam 162 is inserted into the bath and moved horizontally through the bath 150 to remove the impurities in the layer 158.

The metal (e.g., aluminum, magnesium, and/or alloys) reacts with both the lithium melt and nitride constituents in the impurity layer. The interfacial reaction between the lithium/impurity and the metal causes the surface lithium layer along with the slag to adhere to the metal mesh/foam. The pores of the metal mesh/foam offer additional spaces and surface area to entrap the impurities. The impurities in the bath can be quickly removed by spontaneous reaction with the metal mesh/foam. In some examples, impurities in the bath can be removed in less than 5 s.

In some examples, the metal foam/mesh comprises aluminum foam or mesh. However, other metals can be used. In some examples, the metal that is used for the foam/mesh forms more stable oxide and/or nitride bonds than lithium. The metal of the foam/mesh spontaneously reacts with the slag and the lithium (e.g., metal-lithium phase diagrams indicate solubility of lithium in the metal), and the metal does not dissolve into the lithium (e.g., metal-lithium phase diagrams indicate intermetallic formation with lithium that prevents dissolution of the metal into the lithium).

Referring now to FIG. 7, a method for removing impurities is shown. At 210, a metal foam or mesh made of aluminum, magnesium, or alloys thereof is provided. In some examples, multiple layers of metal mesh are stacked together to increase strength/rigidity. At 214, a portion of the metal mesh or foam is immersed in the bath. At 218, the metal mesh or foam is moved horizontally through the bath to remove the slag. At 222, the metal mesh or foam is removed from the bath. After removing the impurities, the bath is used to coat anode current collectors.

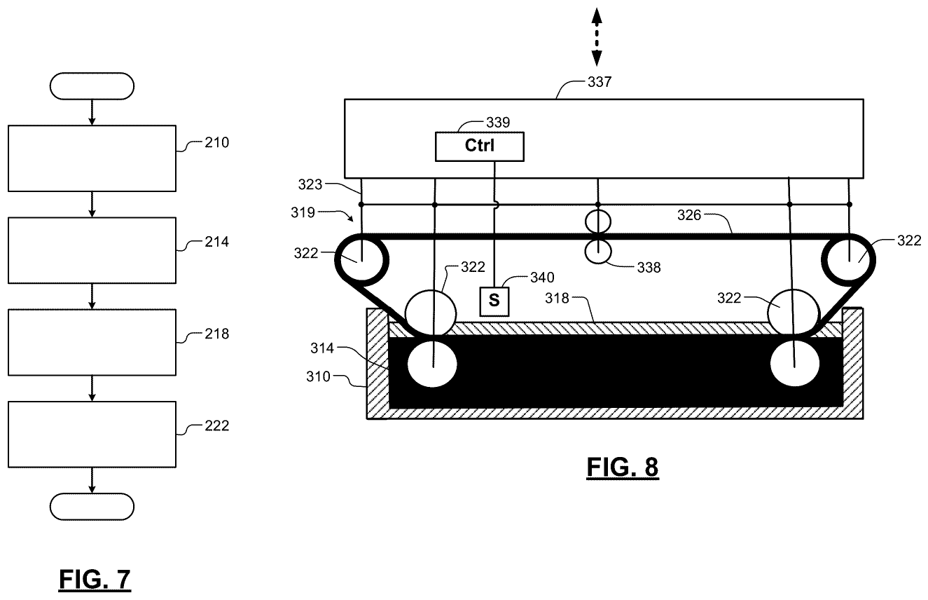

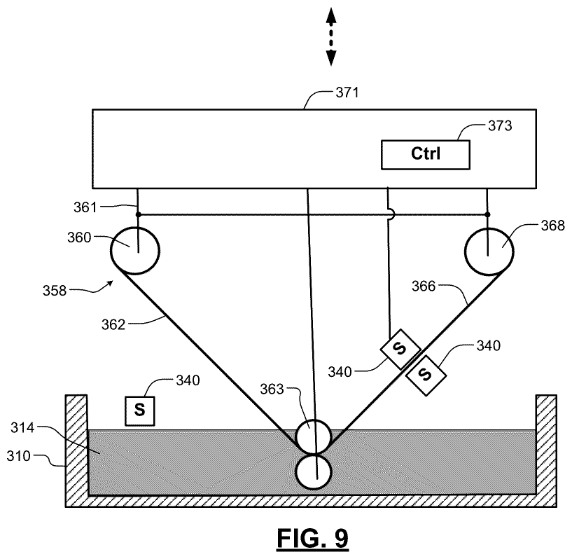

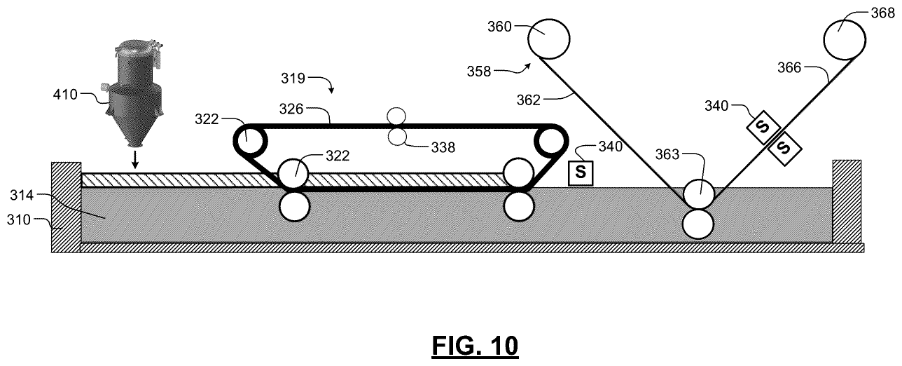

Referring now to FIGS. 8 and 9, a conveyor 319 (to remove impurities) and a current collector feed assembly 358 (to feed the anode current collector) are alternately immersed in a bath 310. In FIG. 8, the bath 310 includes molten lithium 314 with an upper layer 318 including impurities. A conveyor 319 includes a continuous metal mesh or foam belt 326 suspended by rollers 322 connected to a frame 323. The continuous metal mesh or foam belt 326 is directed around the rollers 322 and through at least an upper impurity layer of the bath to remove the impurities in the upper layer 318. In some examples, a brush 338 is used to remove impurities from the continuous metal mesh or foam belt 326. In some examples, one or more sensors 340 are used to sense impurity content. In some, a positioning device 337 is operated in response to the sensor 340 to remove the conveyor 319 when the impurity level falls below a predetermined value. A controller 339 may be used to monitor the sensor 340 and to control the conveyor 319.

In FIG. 9, after the impurities in the upper layer 318 are removed, the conveyor 319 is removed from the bath 310 by the positioning device 337. A current collector feed assembly 358 including a frame 361 is used to feed the anode current collector into the bath 310. A roll 360 mounted to the frame 361 supplies an anode current collector 362 around rollers 363 and through the molten lithium 314 to coat the anode current collector 362 and form an anode electrode 366. The anode electrode 366 is collected on a roll 368. One or more sensors 340 can be used to monitor impurity levels in the bath 310 or on the anode current collector or electrode. A controller 373 monitors one or more of the sensors 340 to detect an impurity level in the bath. When the impurity level in the bath increases above a predetermined level, a positioning device 371 removes the current collector feed assembly 358. In some examples, the positioning devices 337 and 371 are separate devices. In some examples, the positioning devices 337 and 371 are combined into a single device.

In some examples, the impurity or slag layer is removed from the bath using the metal mesh/foam of the conveyor 319. Then, the conveyor 319 is removed from the bath and the current collector feed assembly 358 is at least partially immersed. The anode current collector is directed through the molten lithium and is coated with lithium. One or more sensors are used to monitor impurity pickup in the anode electrode. When the impurity level is greater than a predetermined threshold, the current collector feed assembly 358 is removed and the conveyor 319 is used to remove the impurity layer.

In some examples, the sensor 340 is selected from a group consisting of a vision system (e.g., to detect changes in color, texture, or other visible parameter), a surface reflectivity sensor (to sense changes in reflectivity), an eddy current array (to sense changes in electrical conductivity), an in-line XRF, and a hyperspectral imaging system.

The sensors 340 can be used to provide in-line feedback-controlled nondestructive evaluation (NDE) to monitor the quality of molten lithium bath and dip coated anode to detect impurities. In some examples, one or more sensors 340 provide continuous, wide area surface reflectivity sensing of the molten lithium bath during and/or after the impurity removal process and/or during the dip coating process.

Referring now to FIG. 10, the conveyor 319 and the current collector feed assembly 358 can be used in the same bath to provide continuous production. A hopper 410 is used to supply bulk lithium to the bath 310. Impurities rise to the surface and are removed by the metal mesh or foam belt 326 of the conveyor 319 arranged adjacent to the hopper 410. The current collector feed assembly 358 is arranged adjacent to the conveyor 319 to route the anode current collector through the bath 310.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A method for removing impurities from a bath including molten lithium, comprising:
melting bulk lithium in a bath to form molten lithium including an impurity layer;
immersing one end of one of a metal foam and a metal mesh in the bath;
moving the one of the metal foam and the metal mesh horizontally through the bath to remove the impurity layer; and
removing the one of the metal foam and the metal mesh from the bath.

2. The method of claim 1, wherein the one of the metal foam and the metal mesh is made of a material selected from a group consisting of aluminum, magnesium, and alloys thereof.

3. The method of claim 2, wherein the one of the metal foam and the metal mesh includes the metal foam.

4. The method of claim 2, wherein the one of the metal foam and the metal mesh includes the metal mesh.

5. The method of claim 4, wherein the metal mesh includes a plurality of mesh layers that are stacked.

6. The method of claim 1, wherein the one of the metal foam and the metal mesh has a thickness in a range from 3 to 5 mm.

7. The method of claim 1, wherein:
the impurity layer has a thickness, and
the one of the metal foam and the metal mesh is inserted below a surface of the bath greater than or equal to the thickness of the impurity layer.

8. The method of claim 1, wherein the impurity layer has a thickness in a range from 1 mm to 3 mm below a surface of the bath.

9. The method of claim 1, further comprising coating an anode current collector in the bath after removing the impurity layer.

10. A system for coating anode current collectors with molten lithium, comprising:
a bath including molten lithium including an impurity layer; and
a conveyor assembly including one of a continuous metal mesh and a continuous metal foam arranged around rollers,
wherein the one of the continuous metal foam and the continuous metal mesh is made of a material selected from a group consisting of aluminum, magnesium, and alloys thereof, and
wherein the conveyor assembly is arranged with the one of the continuous metal mesh and the continuous metal foam inserted below a surface of the bath greater than or equal to a thickness of the impurity layer.

11. The system of claim 10, further comprising a sensor configured to sense an impurity level of the impurity layer.

12. The system of claim 11, further comprising a positioning device configured to insert and remove the conveyor assembly from the bath.

13. The system of claim 12, further comprising a controller configured to remove the conveyor assembly from the bath in response to the impurity level being below a predetermined impurity level.

14. The system of claim 10, further comprising a current collector feed assembly including:
a current collector roll configured to supply a current collector;
a roller immersed in the bath; and
a roll configured to receive an anode electrode.

15. The system of claim 14, further comprising a sensor configured to sense an impurity level of the impurity layer.

16. The system of claim 15, further comprising a positioning device configured to insert and remove the current collector feed assembly from the bath.

17. The system of claim 16, further comprising a controller configured to remove the conveyor assembly from the bath in response to the impurity level being above a predetermined impurity level.

18. The system of claim 10, wherein the one of the continuous metal foam and the continuous metal mesh includes the continuous metal mesh.

19. The system of claim 18, wherein the continuous metal mesh includes a plurality of mesh layers that are stacked.

20. A system for coating anode current collectors with molten lithium, comprising:
a bath including molten lithium including an impurity layer;
a conveyor assembly including one of a continuous metal mesh and a continuous metal foam arranged around rollers,
wherein the one of the continuous metal foam and the continuous metal mesh is made of a material selected from a group consisting of aluminum, magnesium, and alloys thereof, and
wherein the conveyor assembly is arranged with the one of the continuous metal mesh and the continuous metal foam inserted below a surface of the bath greater than or equal to a thickness of the impurity layer; and
a current collector feed assembly including a current collector roll configured to supply a current collector, a roller immersed in the bath, and a roll configured to receive an anode electrode,
wherein the one of the continuous metal foam and the continuous metal mesh of the conveyor assembly and the current collector of the current collector feed assembly are immersed in the bath at the same time.
